(19) United States
(12) Patent Application Publication
(10) Pub. No.: US 2010/0072873 A1
(43) Pub. Date: Mar. 25, 2010

(54) HOT-CATHODE FLUORESCENT LAMP

(76) Inventors: Shiro Otake, Osaka (JP); Teruaki Shigeta, Osaka (JP); Takeshi Arakawa, Kyoto (JP); Nobuhiro Shimizu, Nara (JP)

Correspondence Address: SNELL & WILMER L.L.P. (Panasonic), 600 ANTON BOULEVARD, SUITE 1400, COSTA MESA, CA, 92626, US

(21) Appl. No.: 12/447,424

(22) PCT Filed: Nov. 2, 2007
(86) PCT No.: PCT/JP07/71415

§ 371 Date: Apr. 27, 2009

(30) Foreign Application Priority Data
Nov. 2, 2006 (JP) 2006-299665

(51) Int. Cl. H01J 61/52; H01J 63/04

(52) U.S. Cl. 313/38; 313/491

(57) ABSTRACT

A hot-cathode fluorescent lamp includes a pair of filament coils (4) at the respective ends of a glass bulb. Each filament coil (4) has a coiled portion (4a) coated with an electron emissive material, a first lead portion (4b) extending from one end of the coiled portion (4a), and a second lead portion (4c) extending from another end of the coiled portion (4a). The first lead portion (4b) and the second lead portion (4c) are connected to lead-in wires inserted into the glass bulb via connecting members (5a, 5b). At least one insulating member (11a or 11b) is provided between closest edges of the connecting members (5a, 5b) to each other. The provision of the insulating member prevents a short circuit occurring between the closest edges of the plate-shaped connecting members during lighting. Occurrence of such a short circuit would cause lighting to start without the coil portion being sufficiently pre-heated, which results in excessive sputtering of the electron emissive material to shorten the lamp life.

### TECHNICAL FIELD

The present invention relates to a hot-cathode fluorescent lamp mainly used as a backlight in a liquid crystal display apparatus.

### BACKGROUND ART

In recent years there have been demands for larger size liquid crystal display apparatuses, particularly for liquid crystal television receivers and the like. In accordance with such demands, there are also demands for larger size low-pressure discharge lamps to be used as backlights for liquid crystal television receivers.

In response to such demands for larger size liquid crystal television receivers, the present inventors have considered employing a hot-cathode fluorescent lamp as a backlight in view of various advantages including the following. That is, in comparison to cold-cathode fluorescent lamps, hot-cathode fluorescent lamps have higher luminous efficiency, emit a relatively large amount of light, and are easy to assemble.

Generally, a hot-cathode fluorescent lamp is provided with a pair of filament coils coated with electron emissive material. However, there is a problem that the electron emissive material sputters during lighting, causing the hot-cathode fluorescent lamp to have a shorter life than a cold-cathode fluorescent lamp. Patent Document 1 discloses a technique for suppressing such sputtering. Specifically, Patent Document 1 states that a sleeve is provided to cover a filament coil in order to suppress the collision of ions with the filament coil, and thus the occurrence of sputtering is suppressed (see paragraph [0019]).

### Patent Document 1: Japanese Patent Application Publication No. 2005-235749

### DISCLOSURE OF THE INVENTION

### Problem to be Solved by the Invention

In the above-mentioned conventional technology, two lead-out wires that extend from a coiled portion of each filament coil are connected to respective ones of two lead-in wires for supplying power to the filament coil. In such an arrangement, each of the filament coils is supported by a pair of tab-shaped connecting members which have the function of more accurately positioning the filament coils, to prevent contact between the bulb and the filament coil. The use of the connecting members allows the lead-out wires and the lead-in wires to be more easily connected to each other. Each pair of connecting members is disposed such that a main surface of one of the connecting members is parallel to a main surface of the other connecting member with respect to a same virtual plane. This means that one edge of each of the connecting members in the pair is located close to one edge of the other connecting member in the pair, and hence there is a danger of a short circuit occurring between the close edges when the lead-in wires are energized. When this kind of short circuit occurs, lighting of the hot-cathode lamp commences without the filament coil being sufficiently preheated. Lighting without sufficient preheating causes excessive sputtering and thus accelerated consumption of the electron emissive material, compared to when the filament coil is sufficiently preheated, and thus shortens lamp life.

The present invention is conceived in view of the above-described problems, and has an object of providing a hot-cathode fluorescent lamp capable of preventing a short circuit between the connecting members, and thus suppressing shortening of lamp life.

### Means to Solve the Problem

In order to achieve the stated object, a hot-cathode fluorescent lamp of the present invention has a pair of filament coils at respective ends of a glass bulb. Each filament coil has a coiled portion coated with electron emissive material, a first lead portion extending from one end of the coiled portion, and a second lead portion extending from another end of the coiled portion. The hot-cathode fluorescent lamp also has at least one pair of a first connecting member and a second connecting member. The first connecting member is provided on a power supply path to the first lead portion and the second connecting member is provided on a power supply path to the second lead portion. The first and second connecting members are disposed close to each other in the glass bulb. The hot-cathode fluorescent lamp also has at least one insulating member disposed between the first connecting and second connecting members so that the insulating member coincides at least with a location where the first connecting and second connecting members are closest to each other.

### EFFECTS OF THE INVENTION

Due to the at least one insulating member inserted between the closest portions of the first connecting member and the second connecting member, the hot-cathode fluorescent lamp of the present invention can prevent the occurrence of short circuits between the first connecting member and the second connecting member during lighting of the lamp, suppressing excessive consumption caused by excessive sputtering of the electron emissive material attached to the coiled portion, and suppressing reduction in lamp life.

### BRIEF DESCRIPTION OF THE DRAWINGS

FIG. 1A is a schematic cross-sectional view of a hot-cathode fluorescent lamp of a first embodiment of the present invention, and FIG. 1B is cross-sectional view of a principal part of FIG. 1A;

FIG. 2A is a schematic perspective view of an electrode unit in the first embodiment, and FIG. 2B is a schematic cross-sectional view along a virtual plane viewed in the direction of the arrow shown in FIG. 2A;

FIG. 3A is a schematic perspective view of an electrode unit of a second embodiment of the present invention, and FIG. 3B is a schematic cross-sectional view along a virtual plane viewed in the direction of the arrow shown in FIG. 3A; and

FIG. 4A is a schematic perspective view of an electrode unit and an insulating member of a third embodiment, FIG. 4B is a schematic cross-sectional view along a virtual plane viewed in the direction of the arrow shown in FIG. 4A, and FIG. 4C is a schematic planar view showing an insulating member and a vicinity thereof from a direction orthogonal to a main surface of the connecting member.

### EXPLANATION OF REFERENCE

1 Hot-cathode fluorescent lamp
2 Bulb
2a Fluorescent film
3 Electrode unit
3a Electron emissive material
4 Filament coil
4a Coiled portion
4b First lead portion
4c Second lead portion
5a, 5b Connecting member
6a, 6b Lead-in wire
7 Sleeve
8 Sleeve lead
11a, 11b, 12, 13 Insulating member

### BEST MODE FOR CARRYING OUT THE INVENTION

### First Embodiment

The following describes a hot-cathode fluorescent lamp of a first embodiment of the present invention, with reference to the drawings.

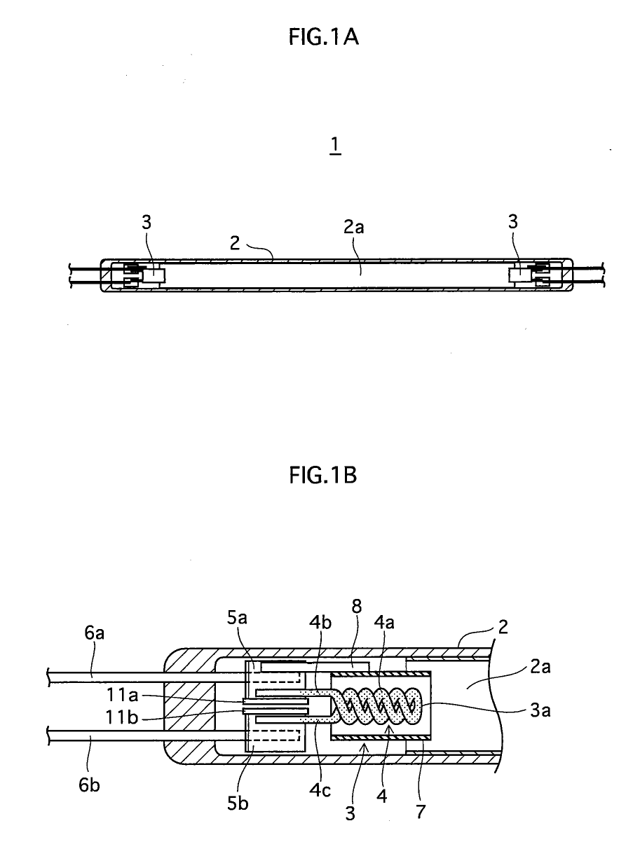

FIG. 1A is a schematic cross-sectional view of the hot-cathode fluorescent lamp of the present embodiment, and FIG. 1B is cross-sectional view of a principal part of FIG. 1A. In FIG. 1A, only a bulb 2 and a fluorescent film 2a formed on an inner surface of the bulb 2 are shown in cross-section. In FIG. 1B, only the bulb 2, the fluorescent film 2a and a sleeve 7 are shown in cross-section. Although FIG. 1B shows only one of electrode units 3 and the surrounding area thereof in cross-section, the other electrode unit 3 and the surrounding area thereof have the same structure as shown in FIG. 1B.

As shown in FIG. 1A, the hot-cathode fluorescent lamp 1 according to the present embodiment includes the bulb 2 which, for example, is a tubular glass bulb having an inner diameter of no less than 5 [mm] and no greater than 10 [mm]. The hot-cathode fluorescent lamp 1 also includes the electrode units 3 housed at respective ends of the bulb 2.

The inner surface of the bulb 2 is coated substantially entirely with the fluorescent film 2a formed thereon, except the part of the inner surface at end portions of the bulb 2. Three types of the fluorescent materials are used for the fluorescent film 2a, specific examples being red (Y₂O₃:Eu), green (LaPO₄:Ce, Tb) and blue (BaMg₂Al₁₆O₂₇:Eu, Mn). The bulb 2 is filled with a rare gas and a luminescent material. Examples of the rare gas include an argon (Ar)-neon (Ne) gas, and examples of the luminescent material include mercury (Hg).

As shown in FIG. 1B, each electrode unit 3 is composed of a filament coil 4, a sleeve 7, a sleeve lead 8, and connecting members 5a and 5b. The filament coil 4 is composed of a coiled portion 4a, a first lead portion 4b, and a second lead portion 4c. The coiled portion 4a is wound in a spiral form and the sleeve 7 is disposed to house the coiled portion 4a.

The sleeve 7 is made of nickel (Ni), molybdenum (Mo), or the like, for instance. The axis of the sleeve 7 is substantially parallel to the winding axis of the coiled portion 4a.

The inner diameter of the sleeve 7 is sufficiently greater than the outer diameter of the coiled portion 4a, so that the sleeve 7 does not contact the coiled portion 4a housed therein. In addition, the outer diameter of the sleeve 7 is sufficiently smaller than the inner diameter of the bulb 2, so that the sleeve 7 does not contact the bulb 2.

The outer diameter of the coiled portion 4a is no less than 1 [mm] but less than 5 [mm], for instance. The first lead portion 4b extends from one end of the coiled portion 4a toward a closer one of the ends of the bulb 2. Similarly, the second lead portion 4c extends from the other end of the coiled portion 4a toward the closer end of the bulb 2.

The filament coil 4 is made of a wire which may have, as the main constituent, tungsten (W), tungsten-rhenium (Re—W), or the like. A wire made mainly of tungsten-rhenium (Re—W) has higher strength under heat, as compared with a wire made mainly of tungsten (W). For this reason, a wire having Tungsten-rhenium (Re—W) as the main constituent is used for the filament coil 4 in the present embodiment.

Wires with a diameter of 25 [μm] to 70 [μm] are usable for the filament coil 4. In the case of a double coil (double helical structure), it is preferable to use a wire having a diameter of 45 [μm] to 55 [μm], from the point of view of both ease of winding and strength.

The coiled portion 4a of the filament coil 4 is in a doubly wound state. This is achieved by first forming a single coil by winding a wire into a spiral shape with a substantially constant pitch, and then forming a double coil by winding the single coil into a spiral shape. As one example, the single coil may have an outer diameter of 0.15 [mm] and a pitch of 0.07 [mm], and the ultimate coiled portion, 4a may have an outer diameter of 1.3 [mm] and a pitch of 0.6 [mm].

An electron emissive material 3a is deposited on the surface of the coiled portion 4a of the filament coil 4. The main constituent of the electron emissive material 3a may be an oxide of a ternary alkaline earth metal made up of barium (Ba), strontium (Sr), and calcium (Ca). The main constituent of the electron emissive material 3a is not limited to the stated material, and may be a binary barium oxide, or may be an oxide of an alkaline earth metal with 1% to 5% by weight of zirconium oxide added thereto.

The sleeve 7 covers the coiled portion 4a of the filament coil 4. The sleeve lead 8 extends from an outer surface of the sleeve 7 toward the closer end of the bulb 2. The sleeve lead 8 may be made of stainless steel (SUS304), for example.

Each of the connecting members 5a and 5b are in the form of plate. The exposed end of the sleeve lead 8 as well as the exposed ends of the first and second lead portions 4b and 4c are separately fixed to one of the connecting members 5a and 5b. As one example, the plate-shaped connecting members 5a and 5b are mainly made of stainless steel (SUS304) and each measure 2-10 [mm] in height, 1-5 [mm] in width, and 0.1-0.5 [mm] in thickness. At each end of the bulb 2, a pair of lead-in wires 6a and 6b is provided through the end of the bulb 2 to energize the first lead portion 4b and the second lead portion 4c, respectively. The ends of the lead-in wires 6a and 6b contained inside the bulb 2 are fixed to the connecting members 5a and 5b.

As described above, the connecting member 5a connects the first lead portion 4b to the lead-in wire 6a, whereas the connecting member 5b connects the second lead portion 4c to the lead-in wires 6b. Therefore, the connecting members 5a and 5b function as feeder members through which electric power is supplied to the filament coil 4 upon voltage application to the lead-in wires 6a and 6b.

In the present embodiment, the sleeve lead 8 and the first lead portion 4b are fixed to one main surface of the plate-shaped connecting member 5a, and the lead-in wire 6a is fixed to the other main surface of the plate-shaped connecting member 5a. Similarly, the second lead portion 4c is fixed to one main surface of the plate-shaped member 5b, and the lead-in wire 6b is fixed to the other main surface of the plate-shaped member 5b.

Since the respective ones of the first and second lead portions 4b and 4c are connected to the respective ones of the lead-in wires 6a and 6b via the connecting members 5a and 5b, the filament coil 4 can be more accurately positioned at the time of assembling the lamp 1, compared to the case where first and second lead wires are connected to respective lead-in wires without using connecting members. In addition, the use of the connecting members 5a and 5b allows the first and second lead portions 4b and 4c to be connected to the respective ones of the lead-in wires 6a and 6b more easily than when connecting members are not used.

The sleeve lead 8 is not necessarily supported by the connecting member 5a, and may be supported by the connecting member 5b instead.

Although the coiled portion 4a of the filament coil 4 according to the present embodiment is a double coil (double helical structure), the coiled portion 4a may alternatively be a triple coil (triple helical structure) or a single coil (single helical structure).

With a coiled coil structure (multiplex winding structure), the coiled portion 4a of the filament coil 4 is made more compact as compared with the single coil structure (single helical structure), which leads to improve the design flexibility of the lamp 1.

An overview of a specific method for driving the hot-cathode fluorescent lamp of the present invention is now given. In order to apply voltage across the first and second lead portions 4b and 4c of the electrode unit 3, a voltage of 5[V], for instance, is applied across the lead-in wires 6a and 6b. As a result, the electron emissive material 3a is heated by the filament coil 4.

Then, a voltage of 300[V], for instance, is applied across the electrode units 3, causing electrons to be emitted from the electron emissive material 3a to generate arc discharge between the electrodes units 3. After arc discharge is generated between the electrode units 3, control is exercised so that a voltage of 100[V] is applied across the electrode units 3, and a voltage of 2[V], for example, is applied to each of the electrode units 3. Although the application of the 2[V] voltage is optional, this leads to longer lamp life.

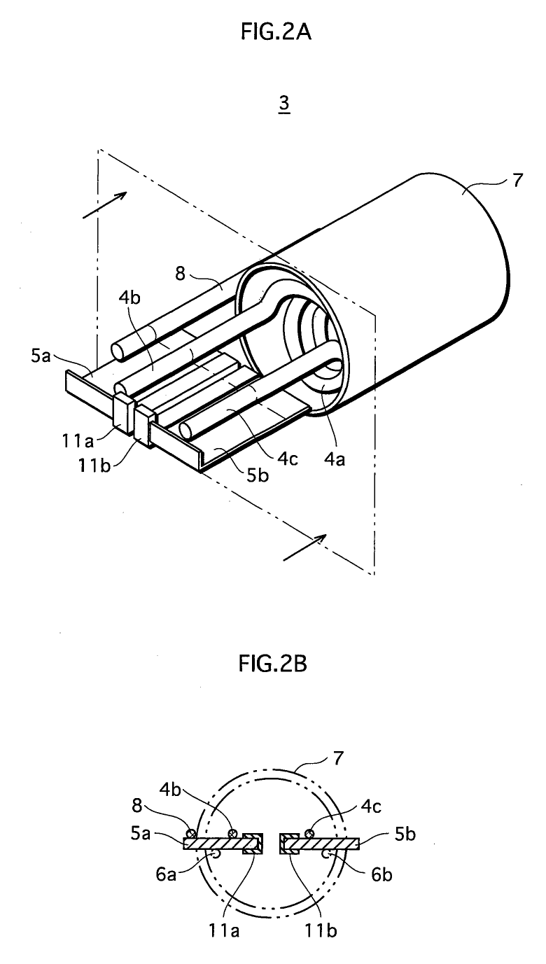

FIG. 2A is a schematic perspective view of the electrode unit, and FIG. 2B is a schematic cross-sectional view along a virtual plane viewed in the direction of the arrow shown in FIG. 2A.

As shown in FIG. 2A, in each of the electrode units 3 of the present embodiment, the plate-shaped connecting members 5a and 5b are disposed such that a main surfaces of the connecting member 5a and a main surfaces of the connecting member 5b are contained within the same virtual plane. As shown in FIGS. 2A and 2B, insulating members 11a and 11b are attached to the connecting members 5a and 5b, specifically the insulating member 11a is on the edge of the connecting member 5a that is closest to the connecting member 5b, and the insulating member 11b is on the edge of the connecting member 5b that is closest to the connecting member 5a. Note that the stated edges are referred to as “closest edges” hereinafter.

In the present embodiment, each of the insulating members 11a and 11b has a thickness of 0.002 [mm] to 1 [mm].

Although the insulating members 11a and 11b are attached to the closest edges of the connecting members 5a and 5b in the present embodiment, it is possible to provide only one insulating member (11a or 11b) on the closest edge of only one of the connecting members (5a or 5b).

The insulating members 11a and 11b are formed on the respective closest edges of the connecting members in the following manner. A glaze having an oxide such as aluminium oxide (Al₂O₃) or silica (SiO₂) or a nitride such as boron nitride (BN) as a main constituent is prepared. The glaze is applied to the respective closest edges of the connecting members 5a and 5b, followed by baking for approximately 10 minutes at 1200[° C.]. Note that in the stated insulating layer formation method using glaze, it is preferable to carry out the process in an oxygen deficient atmosphere in order to prevent oxidization of the connecting members 5a and 5b on which the insulating layer is being formed.

As one example, if a glaze containing a mixture of silica powder and boric acid is applied and baked under the above-stated conditions, the insulating members 11a and 11b can be formed of an insulating layer in which the silica is enveloped by the boric acid that has melted due to the baking.

The insulating members 11a and 11b may be formed on the respective closest edges of the connecting members in the following manner. A paste or slurry is prepared by dispersing powder in a dispersion medium such as a petroleum-based carbide, a carboxylate ester or an alcohol so as to achieve a predetermined viscosity. The main constituent of the powder may be a nitride such as silicon nitride (Si₃N₄), a carbide such as silicon carbide (SiC), or a mixture of two or more of these, for instance a ceramic such as a silica alumina (xM₂OyAl₂O₃ZSiO₂nH₂O). The paste is then applied to the closest edges of the connecting members 5a and 5b, followed by drying at a temperature determined in view of the boiling point and the saturation vapor pressure of the dispersion medium to form the insulating members 11a and 11b.

As one example, if the dispersion medium is butyl oxide, the insulating members 11a and 11b may each be an insulating layer formed by applying a slurry having a viscosity of 0.2-2.0 [Pa s], and blowing the slurry dry with hot air of approximately 40[° C.] for two minutes.

An alternative method is to form the insulating members 11a and 11b in advance by baking a substance such as the above-stated oxide, nitride, carbide or the like, and then attaching the insulating members 11a and 11b to the respective closest edges of the connecting members 5a and 5b using a heat-resistant adhesive.

As one example, a mixture of silica powder and a nitride may baked in a mold in advance to form the insulating members 11a and lib, and the formed insulating members 11a and 11b may be attached to the respective closest edges of the connecting members 5a and 5b using a heat-resistant adhesive.

Alternatively, a substance such as the above-stated oxide, nitride, carbide or the like may be baked in advance to form the insulating members 11a and 11b, and then the formed insulating members 11a and 11b may be disposed on the respective closest edges of the connecting members 5a and 5b using a heat-resistant adhesive.

As one example, a mixture of magnesia powder and silica powder may be baked in a mold to form heat-resistant insulation structures such as stellites or forsterites. The structures are made into a form that fits onto the respective closest edges of the connecting members 5a and 5b according to the shape of the mold and by cutting work. The structures may be arranged between the connecting members 5a and 5b so as to be held by the connecting members 5a and 5b, or may be attached to the respective closest edges of the connecting members 5a and 5b using a heat-resistant adhesive.

The heat-resistant adhesive used in the present embodiment may be a heat-resistant organic adhesive that is resistant to temperatures of 1000[° C.] and higher. Examples of the heat-resistant adhesive that may be used in the present embodiment are “SUMICERAM” (Registered Trademark in Japan, Trademark Registration No. 1269142) manufactured by Asahi Chemical Co., Ltd., and “Bond X” (Registered Trademark in Japan, Trademark Registration No. 2598133) manufactured by Nissan Chemical Industries, Ltd.

A further alternative is to apply a fluorescent suspension containing the same components as the fluorescent film 2a on the closest edges of the connecting members 5a and 5b, and dry the fluorescent suspension at a temperature determined in view of the boiling point and the saturation vapor pressure of the dispersion medium. This forms the insulating members 11a and 11b having the fluorescent as the main constituent on the respective closest edges of the connecting members 5a and 5b.

### <<Effects of the Hot-Cathode Fluorescent Lamp of the First Embodiment>>

In the present embodiment, the insulating members 11a and 11b attached to the respective closest edges of the connecting members 5a and 5b prevent an arc discharge occurring between the closest edges when voltage is applied from the lead-in wires 6a and 6b (see FIG. 1B) to the electrode 4, and therefore prevent a short circuit. This prevents the electron emissive material 3a attached to the coiled portion 4a of the main coil 4 from being sputtered excessively and consumed excessively, and therefore suppresses reduction in lamp life.

As already described, the above-mentioned short circuits can also be prevented if at least one insulating member 11a (or 11b) is provided on one connecting member 5a (or 5b). The effect of preventing the short circuits from occurring, and thus suppressing reduction in lamp life, can be achieved with more certainty if insulating members 11a and 11b are provided on each of the connecting members 5a and 5b.

In the present embodiment, since each of the connecting members 5a and 5b has an exposed portion that is not covered by the respective one of the insulating members 11a and lib, heat conductivity of the connecting members 5a and 5b during lighting is more favorable than if the surface of each connecting members 5a and 5b were to be entirely covered by an insulating member. The present embodiment therefore suppresses unevenness in the amount of heat conducted to the bulb 2, and suppresses breaking of the bulb 2 due to uneven thermal expansion.

According the present embodiment, since the winding axis of the coiled portion 4a coated with the electron emissive material 3a is substantially parallel to the tube axis of the bulb 2, ions generated during discharge predominantly collide with the bend of the coiled portion 4a (i.e., where the coiled portion 4a is turned back). Hence, ion sputtering is suppressed inmost part of the coiled portion other than the bend. This suppresses depletion of the electron emissive material 3a, and therefore suppresses reduction in lamp life.

Furthermore, since the winding axis of the coiled portion 4a is substantially parallel to the tube axis of the bulb 2, the diameter of the bulb 2 can be reduced without reducing the length of the filament coil 4, therefore allowing more flexibility of design of the lamp 1.

Reducing the diameter of the bulb 2 enables the intensity of the lamp to be improved. Since the winding axis of the coiled portion 4a is substantially parallel to the tube axis of the bulb 2, the diameter of the bulb 2 can be reduced without a reduction in the total area of the coiled portion 4a over which the electron emissive material 3a is applied. Therefore, the intensity of the lamp can be improved while suppressing reduction in lamp life.

According to the present embodiment, the sleeve 7 is provided to cover the coiled portion 4a of the filament coil 4. The provision of the sleeve 7 further suppresses sputtering by the ions generated during discharge. Thus, reduction in lamp life is further suppressed.

In the case where the coiled portion 4a of the filament coil 4 has a multiple-coiled coil structure, the winding axis of the most outer winding of the coiled portion 4a is substantially parallel to the tube axis of the bulb 2. As a result, the effect similar to that described above is also achieved.

Electron discharge properties can be improved if electron emissive material is attached to the sleeve 7, at least on the inner surface of the sleeve 7.

The amount of light emitted by the lamp 1 can be increased if a fluorescent layer is provided on the outer surface of the sleeve 7.

### Second Embodiment

The following describes a second embodiment of the present invention, with reference to the relevant views.

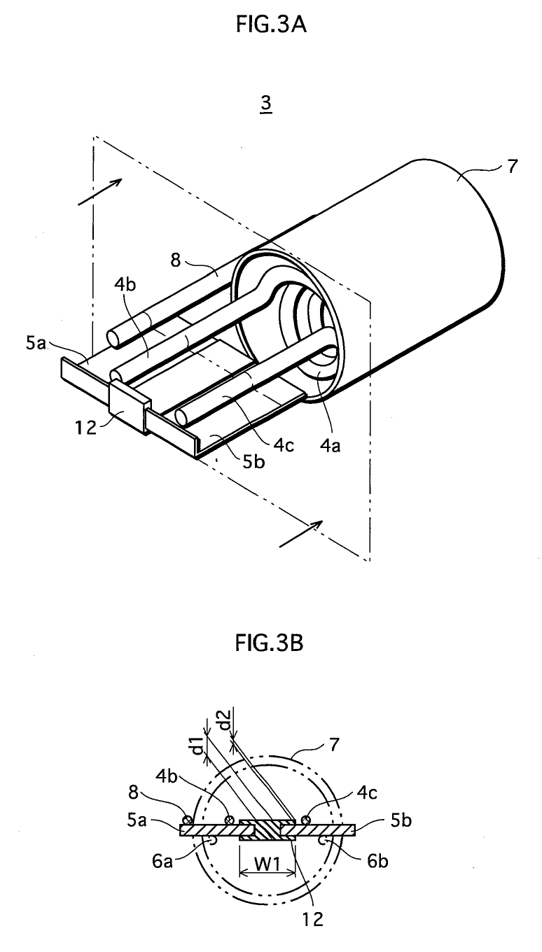

FIG. 3A is a schematic perspective view of an electrode unit of the present embodiment, and FIG. 3B is a schematic cross-sectional view along a virtual plane viewed in the direction of the arrow shown in FIG. 3A.

A feature of the present embodiment is found in the structure of the insulating member. Structure other than the insulating member is the same as in the first embodiment, and therefore a description thereof is omitted here.

As shown in FIG. 3A, in the present embodiment, an insulating member 12 is disposed so as to bridge the closest edges of the connecting members 5a and 5b. More specifically, the insulating member 12 is supported between the closest edges of the connecting members 5a and 5b as shown in FIG. 3B.

In the present embodiment, the insulating member 12 has a width of 4 [mm], a thickness d1 of 3 [mm] at a thickest part, and a thickness d2 of 1 [mm] at a thinnest part.

In the present embodiment, the method shown in the first embodiment is used to form the insulating member 12 by baking an oxide, a nitride, a carbide or the like shown in the first embodiment, and the formed insulating member 12 is attached on the closest edges of the connecting members 5a and 5b using a heat-resistant adhesive.

In the present embodiment, the heat-resistant adhesive is the heat-resistant adhesive used in the first embodiment.

### <<Effects of the Hot-Cathode Fluorescent Lamp of the Second Embodiment>>

In addition to achieving the same effects as the hot-cathode fluorescent lamp of the first embodiment, the hot-cathode fluorescent lamp of the second embodiment also achieves the following. The insulating member 12 bridges the connecting members 5a and 5b, in other words the insulating member 12 is held by the connecting members 5a and 5b, maintaining a certain gap between the connecting members 5a and 5b. This structure more reliably ensures that the parts of the connecting members 5a and 5b not covered by the insulating member 12 (hereinafter, these parts are referred to as exposed portions) are constant spaced apart, as compared to the hot-cathode fluorescent lamp of the first embodiment. This structure also prevents an arc discharge between the exposed portions and thus prevents and a short circuit, thereby suppressing excessive consumption of the electron emissive material 3a attached to the coiled portion 4a of the filament coil 4 caused by excessive sputtering, and suppresses shortening of lamp life.

Furthermore, the hot-cathode fluorescent lamp of the second embodiment can more effectively suppress collision of the connecting members 5a and 5b and suppress breakage of the insulating member 12 compared to the hot-cathode fluorescent lamp of the first embodiment. Therefore, the state of the insulating member 12 inserted between the connecting members 5a and 5b can be maintained over time. Furthermore, this structure also reliably prevents the occurrence of short circuits between the exposed portions over time, suppresses excessive consumption caused by excessive sputtering of the electron emissive material 3a attached to the coiled portion 4a of the filament coil 4 over time, and suppresses shortening of lamp life over time.

### Third Embodiment

The following describes a third embodiment of the present invention, with reference to the relevant views.

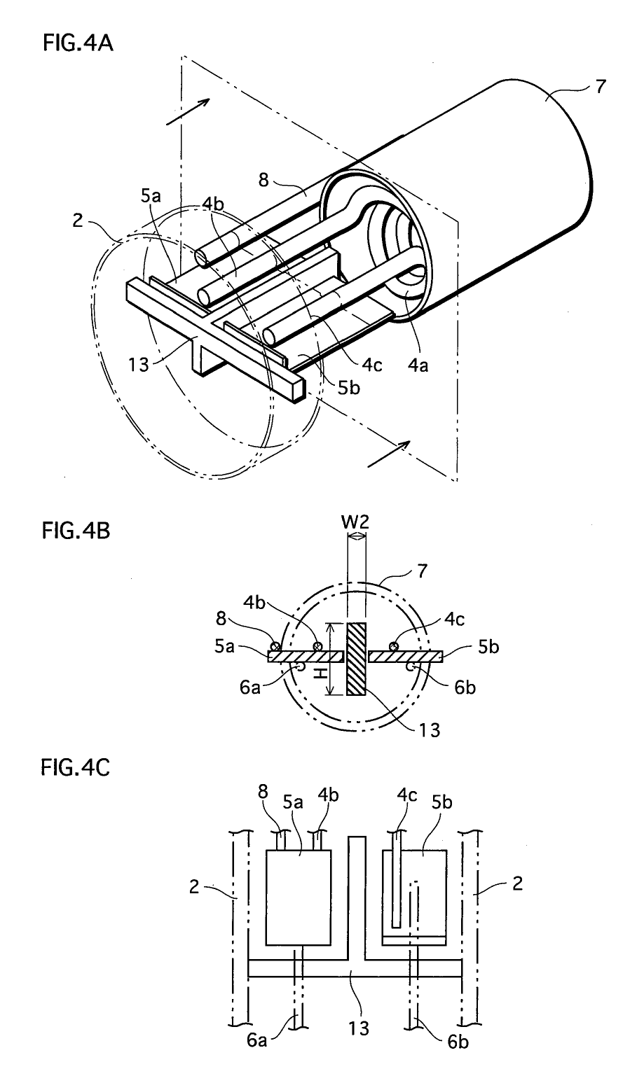

FIG. 4A is a schematic perspective view of an electrode unit and an insulating member of the present embodiment. FIG. 4B is a schematic cross-sectional view along a virtual plane viewed in the direction of the arrow shown in FIG. 4A. FIG. 4C is a schematic planar view showing the insulating member and a vicinity thereof from a direction vertical to a main surface of the connecting member.

A feature of the present embodiment is found in the structure of the insulating member. Structure other than the insulating member is the same as in the first embodiment, and therefore a description thereof is omitted here.

As shown in FIG. 4A, in the present embodiment, an insulating member 13 is provided between the connecting members 5a and 5b in a manner that shields the connecting members 5a and 5b from each other. As shown in FIG. 4B, in a cross section orthogonal to the axis of the sleeve 7, the insulating member 13 is inserted between the connecting members 5a and 5b such that a lengthwise direction of the insulating member 13 is parallel with an orthogonal direction of main surfaces of the connecting members 5a and 5b.

As shown in FIG. 4C, in the present embodiment, the insulating member 13 appears T-shaped when viewed from a direction orthogonal to the main surfaces of the connecting members 5a and 5b, having an arm that reaches an inner wall of the bulb 2. The insulating member 13 is supported by the arms contacting the inner wall of the bulb 2.

The portion of the insulating member 13 that shields the connecting members 5a and 5b from each other is preferably greater in length than the connecting members 5a and 5b in the axial direction of the sleeve 7. If the length of the shielding portion is greater than the connecting members 5a and 5b in the axial direction of the sleeve, arc discharge and a short circuit between the closest sides of the connecting members 5a and 5b to the sleeve 7 can be prevented.

The insulating member 13 has a length H of 5 [mm] in a lengthwise direction that is orthogonal to the main surfaces of the connecting members 5a and 5b, a length W2 of 2.5 [mm] in a widthwise direction, and a thickness of 0.2 [mm].

In the present embodiment, the insulating member 13 is formed by baking the oxide, nitride, carbide or the like shown in the first embodiment using the method shown in the first embodiment. The formed insulating member 13 is attached to the bulb 2 using a heat-resistant adhesive.

In the present embodiment, the heat-resistant adhesive is the heat-resistant adhesive used in the first embodiment.

The material used for the insulating member 13 is not limited to the described material. The entire insulating member 13 may be made of glass as the bulb 2 is. Alternatively, it is possible that the only portion of the insulating member 13 made of glass is the arm portion of the insulating member 13 that attaches to the bulb 2.

### <<Effects of the Hot-Cathode Fluorescent Lamp of the Third Embodiment>>

In addition to achieving the same effects as the hot-cathode fluorescent lamp of the first embodiment, the hot-cathode fluorescent lamp of the third embodiment also achieves the following. Since the lengthwise direction of the insulating member 13 in the direction orthogonal to the axis of the sleeve 7 is parallel to a direction orthogonal to the main surfaces of the connecting members 5a and 5b, the distance between unshielded parts of the connecting members 5a and 5b can be increased. Therefore, this structure prevents a short circuit with certainty, and suppresses with certainty excessive consumption of the electron emissive material 3a attached to the coiled portion 4a of the filament coil 4 caused by excessive sputtering, and suppresses shortening of lamp life with certainty.

If the insulating member 13 is made of the same material as the bulb 2, namely glass, the insulating member 13 and the bulb 2 can be easily made to have the same thermal expansion coefficient, and therefore breakage of the insulating member 13 can be easily suppressed.

In addition, by using this same material for the insulating member 13 and the bulb 2, glass can be used as an adhesive instead of the heat-resistant adhesive, and the thermal expansion coefficient of the adhesive having glass as the main constituent, the bulb 2 and the insulating member 13 can be made the same. This structure suppresses reduction in adhesive strength.

The same effect of suppressing reduction in adhesive strength can also be achieved even when only the aim portion of the insulating member 13 that connects with the bulb 2 is made of glass.

### INDUSTRIAL APPLICABILITY

According to the present invention, reduction in lamp life can be suppressed, and therefore the lamp replacement period can be extended. By using a lamp of the present invention, a maintenance-free lighting apparatus can be realized in relation to life cycle of the product, and therefore the lamp of the present invention can has extremely wide and great industrial applicability.

1. A hot-cathode fluorescent lamp, comprising:
a glass bulb;
a pair of filament coils disposed in respective ends of the glass bulb, each filament coil having a coiled portion coated with an electron emissive material and a first lead portion and a second lead portion extending from respective ends of the coiled portion;
at least one pair of a first connecting member and a second connecting member, the first connecting member connecting the first lead portion of one of the filament coils to a first lead-in wire that outwardly extends through a corresponding one of the ends of the glass bulb, and the second connecting member connecting the second lead portion of the one of the filament coils to a second lead-in wire that outwardly extends through the corresponding one of the ends of the glass bulb; and
at least one insulating member disposed between the first and second connecting members to be coincident at least with a location where the first and second connecting members are closest to each other.

2. The hot-cathode fluorescent lamp of claim 1, wherein
the insulating member is fixed to at least one of the first and second connecting members.

3. The hot-cathode fluorescent lamp of claim 1, wherein
the insulating member bridges between the first connecting member and the second connecting member.

4. The hot-cathode fluorescent lamp of claim 1, wherein
the insulating member is supported by having contact with an inner surface of the glass bulb.

5. The hot-cathode fluorescent lamp of claim 4, wherein
of the insulting member, at least a portion in contact with the glass bulb is made of a same material as the glass bulb.

6. The hot-cathode fluorescent lamp of claim 1, wherein
the first and second connecting members each have a plate shape, and are so disposed that a main surface of the first connecting member and a main surface of the second connecting member are coplanar.

7. The hot-cathode fluorescent lamp of claim 1, wherein
a winding axis of each coiled portion is substantially parallel to a tube axis of the glass bulb.

8. The hot-cathode fluorescent lamp of claim 1, wherein
each coiled portion is a multiple coiled coil, and
an axis of an outermost winding of each coiled portion is substantially parallel to a tube axis of the glass bulb.

9. The hot-cathode fluorescent lamp of claim 7, wherein
each coiled portion is a single coil composed of a wire wound in a spiral with a substantially constant pitch.

10. The hot-cathode fluorescent lamp of claim 8, wherein
each coiled portion is a double coil composed of a single coil wound in a spiral with a substantially constant pitch, the single coil being wound in a spiral with a substantially constant pitch.

11. The hot-cathode fluorescent lamp of claim 7, wherein
each coiled portion is covered by a heat-resistant sleeve.

12. The hot-cathode fluorescent lamp of claim 8, wherein
each coiled portion is covered by a heat-resistant sleeve.
